(19) United States
(12) Patent Application Publication
(10) Pub. No.: US 2025/0267447 A1
(43) Pub. Date: Aug. 21, 2025

(54) METHOD FOR DETERMINING AI-BASED CSI PROCESSING CAPABILITY, AND ELECTRONIC DEVICE

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 18/850,190

(22) PCT Filed: Mar. 31, 2022
(86) PCT No.: PCT/CN2022/084637

§ 371 Date: Sep. 24, 2024

(51) Int. Cl. H04W 8/22

(52) U.S. Cl. CPC H04W 8/22

(57) ABSTRACT

A method for determining an AI-based CSI processing capability is provided. The method includes: receiving a reported AI-based static capability of a terminal; and determining an AI-based CSI processing capability of the terminal on the basis of the static capability.

### CROSS REFERENCE TO RELATED APPLICATIONS

The present disclosure is the U.S. national phase application of International Application No. PCT/CN2022/084637 filed on Mar. 31, 2022, the content of which is incorporated herein by reference in its entirety for all purposes.

### TECHNICAL FIELD

The present disclosure relates to the field of communication, in particular, to a method and an apparatus for determining an AI-based CSI processing capability, a medium, a product, and a chip.

### BACKGROUND

In the 5G New Radio system, obtaining and feedback of Channel State Information (CSI) are crucial, due to the fact that CSI can be used to determine the number of information streams that the channel can carry, the channel quality or signal-to-noise ratio, the channel matrix, etc.

The 3rd Generation Partner Project (3GPP) standardized Type I and Type II codebooks for the CSI feedback. The Artificial Intelligence (AI) technology has also been introduced to achieve the CSI feedback with arbitrary feedback bits and accuracy requirements.

### SUMMARY

According to one aspect of the present disclosure, a method for determining an AI-based CSI processing capability is provided. The method is performed by a network device and includes: receiving a reported AI-based static capability of a terminal; and determining the AI-based CSI processing capability of the terminal based on the static capability.

According to one aspect of the present disclosure, a method for determining an AI-based CSI processing capability is provided. The method is performed a terminal and includes: reporting an AI-based static capability of the terminal to a network device, wherein the AI-based static capability is configured to be used for determination of the AI-based CSI processing capability.

According to one aspect of the present disclosure, an apparatus for determining an AI-based CSI processing capability is provided. The apparatus includes: a first receiving module configured to receive a reported Artificial Intelligence (AI) based static capability of a terminal; and a first processing module configured to determine the AI-based CSI processing capability of the terminal based on the static capability.

According to one aspect of the present disclosure, an apparatus for determining an AI-based CSI processing capability is provided. The apparatus includes: a second sending module configured to report an AI-based static capability of a terminal to a network device, wherein the AI-based static capability is configured to be used for determination of the AI-based CSI processing capability.

According to one aspect of the present disclosure, a network device is provided. The network device includes: a processor; and a transceiver connected to the processor; wherein the processor is configured to load and execute executable instructions to cause the method for determining the AI-based CSI processing capability as described in the above aspects to be implemented.

According to one aspect of the present disclosure, a terminal is provided. The terminal includes: a processor; and a transceiver connected to the processor; wherein the processor is configured to load and execute executable instructions to cause the method for determining the AI-based CSI processing capability as described in the above aspects to be implemented.

According to one aspect of the present disclosure, a computer-readable storage medium is provided. The computer-readable storage medium stores at least one instruction, at least one program, a code set, or an instruction set. The at least one instruction, the at least one program, the code set, or the instruction set is loaded and executed by a processor to cause the method for determining the AI-based CSI processing capability as described in the above aspects to be implemented.

According to one aspect of the present disclosure, a computer program product (or computer program) is provided. The computer program product (or computer program) includes computer instructions stored in a computer-readable storage medium. A processor of a computer device reads and executes the computer instructions from the computer-readable storage medium, to cause the computer device to implement the method for determining the AI-based CSI processing capability as described in the above aspects.

According to one aspect of the present disclosure, a chip is provided. The chip includes a programmable logic circuit and/or program instructions. When the chip is running, the method for determining the AI-based CSI processing capability as described in the above aspects is caused to be implemented.

It should be understood that the general description in the above and the detailed description in the following are only exemplary and explanatory, and cannot limit the present disclosure.

### BRIEF DESCRIPTION OF THE DRAWINGS

In order to provide a clearer explanation of technical solutions in embodiments of the present disclosure, a brief introduction to the drawings required in the description of embodiments of the present disclosure will be provided in the following. It is apparent that the drawings are only some of the embodiments of the present disclosure, and for those skilled in the art, other drawings can be obtained based on these drawings without creative efforts.

FIG. 1 is a block diagram of a communication system according to one or more embodiments;

FIG. 2 is a flowchart of a method for determining an AI-based CSI processing capability according to one or more embodiments;

FIG. 3 is a flowchart of a method for determining an AI-based CSI processing capability according to one or more embodiments;

FIG. 4 is a flowchart of a method for determining an AI-based CSI processing capability according to one or more embodiments;

FIG. 5 is a flowchart of a switching method for a CSI processing mode according to one or more embodiments;

FIG. 6 is a flowchart of a switching method for a CSI processing mode according to one or more embodiments;

FIG. 7 is a flowchart of a method for determining an AI-based CSI processing capability according to one or more embodiments;

FIG. 8 is a flowchart of a switching method for a CSI processing mode according to one or more embodiments;

FIG. 9 is a flowchart of a switching method for a CSI processing mode according to one or more embodiments;

FIG. 10 is a block diagram of an apparatus for determining an AI-based CSI processing capability according to one or more embodiments;

FIG. 11 is a block diagram of an apparatus for determining an AI-based CSI processing capability according to one or more embodiments;

FIG. 12 is a schematic diagram of a structure of a terminal according to one or more embodiments; and

FIG. 13 is a schematic diagram of a structure of a network device according to one or more embodiments.

### DETAILED DESCRIPTION

A detailed explanation of embodiments will be provided herein, which are illustrated in the drawings. The following description when referring to the drawings, unless otherwise indicated, the same reference numerals in different drawings represent the same or similar elements. The embodiments described in the following do not represent all embodiments consistent with the present disclosure. On the contrary, the embodiments are only examples of devices and methods consistent with some aspects of the present disclosure as detailed in the appended claims.

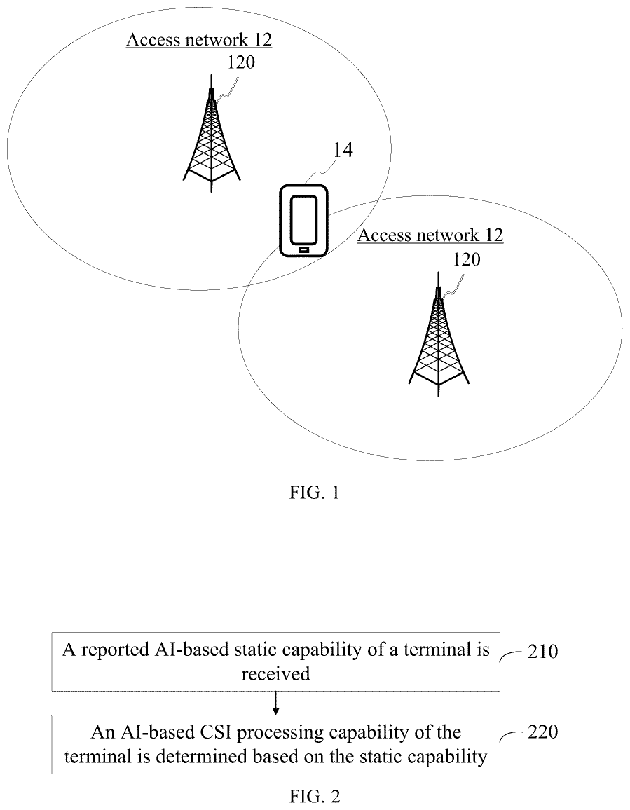

FIG. 1 shows a block diagram of a communication system according to one or more embodiments of the present disclosure. The communication system can include an access network 12 and a user terminal 14.

The access network 12 includes several network devices 120. The network device (also referred to as the access network device) 120 can be a base station. The base station is a device deployed in the access network to provide wireless communication functionalities for the user terminal (also referred to as terminal) 14. The base station can include various forms of macro base stations, micro base stations, relay stations, or access point, and so on. In systems using different wireless access technologies, the names of the devices with a base station functionality may vary. For example, in the Long Term Evolution (LTE) system, the base station is called eNodeB or eNB, and in the 5G NR (New Radio) system, the base station is called gNodeB or gNB. With the evolution in the communication technology, the description of “base station” may change. For the convenience of description in embodiments of the present disclosure, the devices that provide the wireless communication functionality for the user terminal 14 are collectively referred to as network devices.

The user terminal 14 can include various devices with the wireless communication capability, such as handheld devices, vehicle mounted devices, wearable devices, computing devices or other processing devices connected to the wireless modem, as well as user devices, mobile stations (MS), terminal devices, of various forms, and so on. For the convenience of description, the above devices are collectively referred to as user terminals. The network device 120 and the user terminal 14 communicate with each other through some air interface technology, for example, the Uu interface.

There are two communication scenarios between the network device 120 and the user terminal 14, for example, the uplink communication scenario and the downlink communication scenario. In some embodiments, the uplink communication refers to sending signals to the network device 120, and the downward communication refers to sending signals to the user terminal 14.

Embodiments of the present disclosure can be applied to various communication systems, such as Global System of Mobile (GSM) Communication systems, Code Division Multiple Access (CDMA) systems, Wideband Code Division Multiple Access (WCDMA) systems, General Packet Radio Service (GPRS) systems, Long Term Evolution (LTE) systems, LTE Frequency Division Duplex (FDD) systems, LTE Time Division Duplex (TDD) systems, Advanced Long Term Evolution (LTE-A) systems, New Radio (NR) systems, evolution systems for NR systems, LTE-based access to Unlicensed spectrum (LTE-U) systems, NR-U systems, Universal Mobile Telecommunication systems (UMTS), Worldwide Interoperability for Microwave Access (WiMAX) communication systems, Wireless Local Area Networks (WLAN), Wireless Fidelity (WiFi), next generation communication systems, or other communication systems.

The traditional communication systems often support a limited number of links, which are easy to achieve. However, with the development of the communication technology, mobile communication systems will not only support traditional communication, but also support, for example, Device to Device (D2D) communication, Machine to Machine (M2M) communication, Machine Type Communication (MTC), Vehicle to Vehicle (V2V) communication, and Vehicle to Everything (V2X) systems. Embodiments of the present disclosure can also be applied to these communication systems.

In the AI-based CSI processing, an important scenario is the CSI compression. The terminal can input full channel information or feature vectors measured into the AI model for compression, achieving the AI-based CSI compression.

FIG. 2 shows a flowchart of a method for determining an AI-based CSI processing capability according to one or more embodiments of the present disclosure. The method is applied to the network device in the communication system shown in FIG. 1, and the method includes following steps.

In step 210, a reported AI-based static capability of a terminal is received.

In some embodiments, the AI-based static capability is configured to indicate the AI-based computing capability of the terminal.

In some embodiments, the AI-based static capability of the terminal includes at least one of the following.

Information of Hardware with AI-Based Processing Capability

In some embodiments, the information of the hardware with the AI-based processing capability is configured to indicate the AI-based processing capability of the terminal. In some embodiments, the information of the hardware with the AI-based processing capability includes the information of the hardware used by the terminal to process CSI compression. In some embodiments, the information of the hardware used by the terminal to process the CSI compression includes at least one of information of an AI processing chip, or information of a graphic processing unit (GPU).

The information of the hardware with the AI-based processing capability can be further configured to indicate a capability grade of the AI-based processing capability that the terminal has. In some embodiments, the information of the hardware used by the terminal to process the CSI compression includes a hardware capability grade. In some embodiments, the hardware capability grade is defined based on performance parameters of the hardware, that is, the hardware grade is defined based on the hardware capability. The terminal determines the hardware capability grade based on the performance parameters of the hardware, and reports the hardware capability grade.

In some embodiments, the information of the hardware used by the terminal to process the CSI compression includes the performance parameters of the hardware, for example, the performance parameters of the AI processing chip, the performance parameters of the graphic processing unit, etc. The network device can then use the performance parameters of the hardware directly to determine the AI-based CSI processing capability of the terminal. In some embodiments, the network device can also determine the hardware capability grade of the terminal based on the performance parameters of the hardware, and determine the AI-based CSI processing capability of the terminal based on the hardware capability grade. In some embodiments, the information of the AI processing chip can include the performance parameters of the AI processing chip, and the information of the graphic processing unit can include the performance parameters of the graphic processing unit.

### Support Status for AI Processing Platform

The support status for the AI processing platform is configured to indicate the AI processing platform supported by the terminal. In some embodiments, the AI processing platform is used to provide the terminal with the AI-based CSI processing capability. In the case where the terminal supports the AI processing platform, the terminal can perform the AI-based CSI processing through the AI processing platform.

In some embodiments, the AI processing platform includes TenserFlow, which is an end-to-end open-source platform for machine learning.

In some embodiments, at least one AI processing platform/framework is predefined in the communication protocol. In the case where the support status for the AI processing platform indicates that the terminal supports any of the at least one AI processing platform/framework, the network device can determine that the terminal supports the AI-based CSI processing, meaning that the terminal has the AI-based CSI processing capability.

In some embodiments, the support status for the AI processing platform can be reported by the terminal through the BitMap.

### Support Status for Third-Party AI Model Library

The support status for the third-party AI model library is configured to indicate the AI model supported by the terminal. In some embodiments, the AI model supported by the terminal can include at least one of the Convolutional Neural Network (CNN) model, the Deep Neural Network (DNN) model, the Recurrent Neural Network (RNN) model, or the Transformer model.

In some embodiments, the third-party AI model library is used to provide the terminal with the AI-based CSI processing capability. In the case where the terminal supports the third-party AI model library, the terminal can perform the AI-based CSI processing through the AI model provided in the third-party AI model library.

In some embodiments, at least one AI model is predefined in the communication protocol. In the case where the support status for the third-party AI model library indicates that the third-party AI model library supports the terminal to call any of the at least one AI model, the network device can determine that the terminal supports the AI-based CSI processing, meaning that the terminal has the AI-based CSI processing capability.

In some embodiments, the support status for the third-party AI model library can be reported by the terminal through the BitMap.

In step 220, an AI-based CSI processing capability of the terminal is determined based on the static capability.

The network device determines the AI-based CSI processing capability of the terminal based on the AI-based static capability of the terminal. In some embodiments, the AI-based CSI processing capability includes a minimum latency for the AI-based CSI processing, and the minimum latency for the AI-based CSI processing of the terminal corresponding to the AI-based static capability is determined from a corresponding relationship. In some embodiments, the corresponding relationship refers to a mapping relationship between the AI-based static capability and the minimum latency for the AI-based CSI processing.

In some embodiments, the above corresponding relationship is configured in the network device, or the above corresponding relationship is defined in the communication protocol. In some embodiments, the above corresponding relationship includes at least one of the following:
a mapping relationship between information of hardware with an AI-based processing capability and a minimum latency for AI-based CSI processing;
a mapping relationship between a support status for an AI processing platform and a minimum latency for AI-based CSI processing;
a mapping relationship between a support status for a third-party AI model library and a minimum latency for AI-based CSI processing;
a mapping relationship between information of hardware with an AI-based processing capability, a support status for an AI processing platform, and a minimum latency for AI-based CSI processing;
a mapping relationship between information of hardware with an AI-based processing capability, a support status for a third-party AI model library, and a minimum latency for AI-based CSI processing;
a mapping relationship between a support status for an AI processing platform, a support status for a third-party AI model library, and a minimum latency for AI-based CSI processing.

In some embodiments, after obtaining the AI-based CSI processing capability of the terminal, the network device configures an AI-based CSI processing mode and an allowable latency for the AI-based CSI processing for the terminal based on the AI-based CSI processing capability of the terminal.

It should be noted that the terminal does not report the AI-based static capability when the terminal itself does not have the AI-based processing capability. In some embodiments, the network device defaults that the terminal only supports CSI processing modes other than the AI-based CSI processing mode, and the terminal reports based on the CSI processing modes other than the AI-based CSI processing mode.

According to the method for determining the AI-based CSI processing capability provided in embodiments of the present disclosure, the network device can determine the AI-based CSI processing capability of the terminal based on the AI-based static capability reported by the terminal. The method provides a mechanism for the terminal to report the CSI processing capability of itself, which can provide supports for the network device in determining of the CSI processing capability of the terminal, so as to configure the AI-based CSI compression that matches with the CSI processing capability of the terminal.

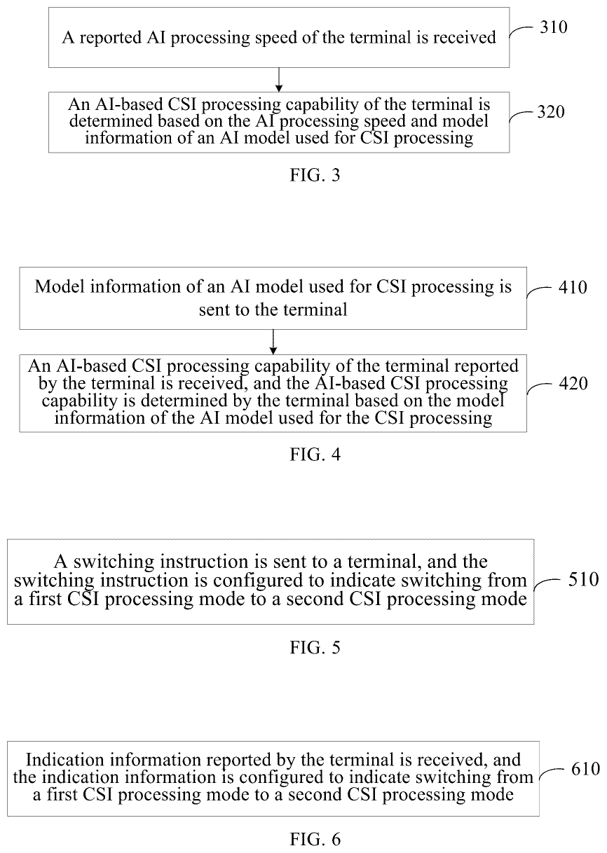

The network device can determine the AI-based CSI processing capability of the terminal directly based on the corresponding relationship between the AI-based static capability and the AI-based CSI processing capability, as shown in step 220 in FIG. 2. In some embodiments, the network device can also determine the AI-based CSI processing capability of the terminal based on an AI processing speed reported by the terminal, as shown in FIG. 3. The method for determining the AI-based CSI processing capability includes following steps.

In step 310, a reported AI processing speed of the terminal is received.

The AI processing speed of the terminal is measured by the terminal and reported to the network device. In some embodiments, the AI processing speed of the terminal is indicated by hardware parameters of the hardware on the terminal, which are obtained by the terminal and reported to the network device. In some embodiments, the hardware parameters of the AI chip on the terminal indicate the AI processing speed of the AI chip, and the terminal obtains the AI processing speed of the AI chip from a designated storage position and reports them to the network device.

In some embodiments, the above AI processing speed is reported by the terminal to the network device actively. In some embodiments, the above AI processing speed is reported by the terminal to the network device in response to the request from the network device. In some embodiments, before receiving the reported AI processing speed of the terminal, the network device sends an obtaining request for the AI processing speed to the terminal, and the terminal reports the AI processing speed of itself to the network device based on the above obtaining request.

In step 320, an AI-based CSI processing capability of the terminal is determined based on the AI processing speed and model information of an AI model used for CSI processing.

The above model information of the AI model used for the CSI processing is configured by the network device for the terminal. In some embodiments, the above model information of the AI model used for the CSI processing can be configured, by the network device, for the terminal based on the AI-based static capability of the terminal. In some embodiments, the above model information can include a model size. The above model information of the AI model used for the CSI processing is the model information of the AI model after switching configured by the network device for the terminal.

In some embodiments, after obtaining the AI-based CSI processing capability of the terminal, the network device configures an AI-based CSI processing mode and an allowable latency for the AI-based CSI processing for the terminal based on the AI-based CSI processing capability of the terminal.

In some embodiments, the above AI-based CSI processing capability can be represented by a grade of the AI-based CSI processing capability.

According to the method for determining the AI-based CSI processing capability provided in embodiments of the present disclosure, the network device can determine the AI-based CSI processing capability of the terminal based on the AI processing speed of the terminal, in combination with the model information of the AI model used for the CSI processing. In the case where the terminal has the AI-based processing capability, the network device is further supported to determine whether the CSI processing capability of the AI model configured for the terminal meets a latency requirement, and configure the terminal if the latency requirement is met, so that the terminal can perform the CSI compression based on AI.

In some embodiments, the network device can also receive the AI-based CSI processing capability reported by the terminal. In some embodiments, as shown in FIG. 4, the method for determining the AI-based CSI processing capability can also include following steps.

In step 410, model information of an AI model used for CSI processing is sent to the terminal.

The network device issues the model information of the AI model used for the CSI processing to the terminal, and the terminal determines the AI-based CSI processing capability of itself based on its AI processing speed of the terminal and the model information of the AI model used for the CSI processing.

In some embodiments, the network device configures the model information of the AI model used for the CSI processing for the terminal based on the AI-based static capability of the terminal, and sends the model information of the AI model used for the CSI processing to the terminal. In some embodiments, the above model information can include a model size. In some embodiments, the above model information of the AI model used for the CSI processing can be the model information of the AI model after switching configured by the network device for the terminal.

In some embodiments, the AI processing speed of the terminal is measured by the terminal. In some embodiments, the AI processing speed of the terminal is indicated by hardware parameters the hardware on the terminal, and is obtained by the terminal. In some embodiments, the hardware parameters of the AI chip on the terminal indicate the AI processing speed of the AI chip, and the terminal obtains the AI processing speed from a designated storage position.

In step 420, an AI-based CSI processing capability of the terminal reported by the terminal is received, and the AI-based CSI processing capability is determined by the terminal based on the model information of the AI model used for the CSI processing.

In some embodiments, after obtaining the AI-based CSI processing capability of the terminal, the network device configures an AI-based CSI processing mode and an allowable latency for the AI-based CSI processing for the terminal based on the AI-based CSI processing capability of the terminal.

In some embodiments, the above AI-based CSI processing capability can be represented by a grade of the AI-based CSI processing capability.

According to the method for determining the AI-based CSI processing capability provided in embodiments of the present disclosure, the network device can issue the model information of the AI model used for the CSI processing, and then receive the AI-based CSI processing capability of the terminal reported by the terminal, which supports the network device to determine, when the terminal has the AI-based processing capability, whether the CSI processing capability of the AI model configured for the terminal meets the latency requirement, and configure the terminal if the latency requirement is met, allowing the terminal to perform the CSI compression based on AI.

The network device configures a CSI processing mode for the terminal based on the AI-based CSI processing capability of terminal, so as to achieve the switching between CSI processing modes. In some embodiments, as shown in FIG. 5, a flowchart of a switching method for a CSI processing mode according to one or more embodiments of the present disclosure is provided. The method is applied to the network device in the communication system shown in FIG. 1, and the method includes following steps.

In step 510, a switching instruction is sent to a terminal, and the switching instruction is configured to indicate switching from a first CSI processing mode to a second CSI processing mode.

In some embodiments, the first CSI processing mode is an AI-based CSI processing mode, and the second CSI processing mode is a CSI processing mode other than the AI-based CSI processing mode. In some embodiments, the second CSI processing mode is an AI-based CSI processing mode, and the first CSI processing mode is a CSI processing mode other than the AI-based CSI processing mode. In some embodiments, the CSI processing mode other than the AI-based CSI processing mode can be a traditional CSI processing mode. In some embodiments, the latency corresponding to the AI-based CSI processing mode is less than the latency corresponding to the CSI processing mode other than the AI-based CSI processing mode.

In some embodiments, the first CSI processing mode is an AI-based CSI processing mode, and the second CSI processing mode is a CSI processing mode other than the AI-based CSI processing mode, then in the case where a probability of a Negative Acknowledgement (NACK) feedback from the terminal increases when the AI-based CSI compression is used, the network device sends the switching instruction to the terminal.

In some embodiments, the above switching instruction includes a semi-static instruction. The semi-static instruction is configured to instruct the terminal to perform the CSI feedback according to the CSI processing mode indicated by the switching instruction within a certain period of time. In some embodiments, the feedback from the terminal when the terminal is using the AI-based CSI compression refers to the feedback on whether the data transmission is correct.

In some embodiments, the above switching instruction includes a dynamic instruction. The dynamic instruction is configured to instruct the terminal to perform the CSI feedback according to the CSI processing mode indicated by the switching instruction.

In some embodiments, in the case where the network device triggers semi-static switching for the CSI processing mode, the switching instruction is a semi-static instruction, and in the case where the network device triggers dynamic switching for the CSI processing mode, the switching instruction is a dynamic instruction.

According to the switching method for the CSI processing mode provided in embodiments of the present disclosure, the semi-static switching and the dynamic switching between two CSI processing modes triggered by the network device are supported. Due to the fact that the semi-static instruction occupies fewer signaling resources, when the network device uses the semi-static instruction to instruct the terminal to switch CSI processing modes, signaling resources can be saved. The dynamic instruction can achieve switching between CSI processing modes more flexibly. The switching between CSI processing modes enables the CSI compression to better match with the latency requirement of terminal services and the transmission rate in the channel environment.

In some embodiments, the above switching between the CSI processing modes can also be the semi-static switching that is triggered by the terminal. In some embodiments, when the AI-based processing capability of the terminal does not match with the latency requirement, the terminal sends a switching request to the network device. The switching request is configured to request the switching of the CSI processing mode. The network device sends the switching instruction to the terminal, and the terminal switches from the first CSI processing mode to the second CSI processing mode based on the switching instruction. According to embodiments, the method also supports the semi-static switching between two CSI processing modes triggered by the terminal, so that the signaling resources can be saved.

The above switching of the CSI processing mode can also be triggered by the terminal. In some embodiments, as shown in FIG. 6, a flowchart of a switching method for a CSI processing mode according to one or more embodiments of the present disclosure is provided. The method is applied to the network device in the communication system shown in FIG. 1, and the method includes following steps.

In step 610, indication information reported by the terminal is received, and the indication information is configured to indicate switching from a first CSI processing mode to a second CSI processing mode.

In some embodiments, the first CSI processing mode is an AI-based CSI processing mode, and the second CSI processing mode is a CSI processing mode other than the AI-based CSI processing mode. In some embodiments, the second CSI processing mode is an AI-based CSI processing mode, and the first CSI processing mode is a CSI processing mode other than the AI-based CSI processing mode. In some embodiments, the CSI processing mode other than the AI-based CSI processing mode can be a traditional CSI processing mode. In some embodiments, the latency corresponding to the AI-based CSI processing mode is less than the latency corresponding to the CSI processing mode other than the AI-based CSI processing mode.

The above indication information is configured to instruct the network device to process the feedback information on CSI from the terminal based on the second CSI processing mode. In some embodiments, the above indication information is reported by the terminal to the network device, after the terminal switches from the first CSI processing mode to the second CSI processing mode. In some embodiments, the above indication information is reported to the network device by the terminal, after the terminal switches from the first CSI processing mode to the second CSI processing mode based on a matching degree between a latency required by a service and a latency corresponding to the AI-based processing capability. In some embodiments, the above indication information is reported to the network device by the terminal, after the terminal switches from the first CSI processing mode to the second CSI processing mode based on a matching degree between a transmission rate corresponding to the channel environment and a latency corresponding to the AI-based processing capability. In some embodiments, the above matching degree is used to indicate whether the latency corresponding to the AI-based processing capability matches or does not match with the latency required by the service. In some embodiments, the above matching degree is used to indicate whether the latency corresponding to the AI-based processing capability matches or does not match with the transmission rate corresponding to the channel environment.

In some embodiments, the network device can receive the indication information sent by the terminal through a notification instruction, and then further receive the feedback information on CSI sent by the terminal. In some embodiments, the terminal can send the indication information to the network device through the notification instruction, and further send the feedback information on CSI to the network device after sending the notification instruction to the network device.

In some embodiments, the network device can also receive the feedback information on CSI sent by the terminal, and the feedback information on CSI carries the above indication information regarding switching to the second CSI processing mode by the terminal. The network device obtains the indication information from the feedback information on CSI, and according to the instruction provided, processes the feedback information on CSI from the terminal based on the second CSI processing mode. In some embodiments, the terminal can carry the indication information regarding the CSI processing mode through the feedback information on CSI.

In some embodiments, the indication information is reported to the network device by the terminal, after the terminal switches from the first CSI processing mode to the second CSI processing mode in the case where the AI-based processing capability of the terminal does not match with the latency requirement. In some embodiments, the latency requirement include the latency required by the service of the terminal. In some embodiments, that the latency corresponding to the AI-based processing capability matches with the latency required by the service of the terminal includes at least one of the following:
a latency corresponding to an AI-based processing capability is the same as a latency required by a service of a terminal;
a latency corresponding to an AI-based processing capability is within a range of a latency required by a service of a terminal.

In some embodiments, that the latency corresponding to the AI-based processing capability does not match with the latency required by the service of the terminal includes at least one of the following:
a latency corresponding to an AI-based processing capability is greater than a maximum latency required by a service of a terminal;
a latency corresponding to an AI-based processing capability is less than a minimum latency required by a service of a terminal.

In the case where the terminal is using the first CSI processing mode, if the latency corresponding to the AI-based processing capability of the terminal is less than the minimum latency required by the service of the terminal, meaning that the AI-based processing capability of the terminal does not match with the latency required by the service of the terminal, the terminal will switch from the first CSI processing mode to the second CSI processing mode and send the indication information to the network device.

According to the switching method for the CSI processing mode provided in embodiments of the present disclosure, the dynamic switching between the CSI processing modes triggered by the terminal is supported, so that the flexibly switching of the CSI processing mode can be achieved, and the switching is triggered by the terminal, which can also speed up the switching efficiency of the switching of the CSI processing mode.

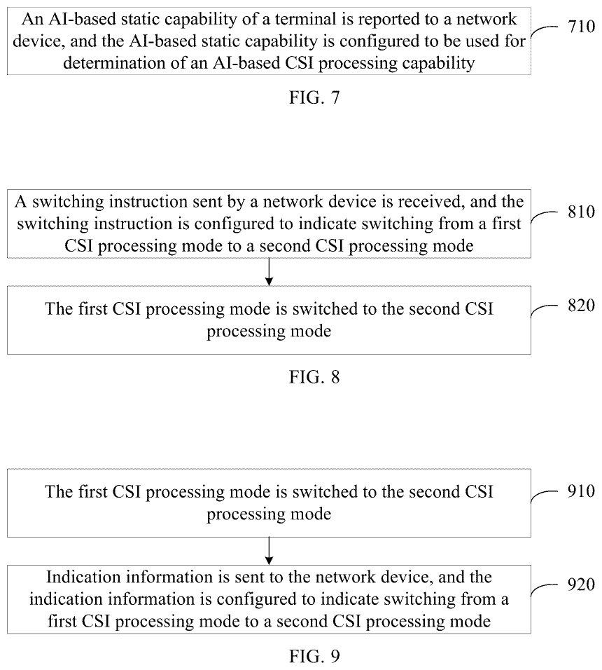

FIG. 7 shows a flowchart of a method for determining an AI-based CSI processing capability according to one or more embodiments of the present disclosure. The method is applied to the terminal in the communication system shown in FIG. 1, and the method includes following steps.

In step 710, an AI-based static capability of a terminal is reported to a network device, and the AI-based static capability is configured to be used for determination of an AI-based CSI processing capability.

In some embodiments, the AI-based static capability includes at least one of the following:

Information of Hardware with AI-Based Processing Capability

In some embodiments, the information of the hardware with the AI-based processing capability is configured to indicate the AI-based processing capability of the terminal. In some embodiments, the information of the hardware with the AI-based processing capability includes the information of the hardware used by the terminal to process CSI compression. In some embodiments, the information of the hardware used by the terminal to process the CSI compression includes at least one of information of an AI processing chip, or information of a graphic processing unit.

The information of the hardware with the AI-based processing capability can be further configured to indicate a capability grade of the AI-based processing capability that the terminal has. In some embodiments, the information of the hardware used by the terminal to process the CSI compression includes a hardware capability grade. In some embodiments, the hardware capability grade is defined based on performance parameters of the hardware, that is, the hardware grade is defined based on the hardware capability. The terminal determines the hardware capability grade based on the performance parameters of the hardware, and reports the hardware capability grade.

In some embodiments, the information of the hardware used by the terminal to process the CSI compression includes the performance parameters of the hardware, for example, the performance parameters of the AI processing chip, the performance parameters of the graphic processing unit, etc. The network device can then use the performance parameters of the hardware directly to determine the AI-based CSI processing capability of the terminal. In some embodiments, the network device can also determine the hardware capability grade of the terminal based on the performance parameters of the hardware, and determine the AI-based CSI processing capability of the terminal based on the hardware capability grade. In some embodiments, the information of the AI processing chip can include the performance parameters of the AI processing chip, and the information of the graphic processing unit can include the performance parameters of the graphic processing unit.

### Support Status for AI Processing Platform

The support status for the AI processing platform is configured to indicate the AI processing platform supported by the terminal. In some embodiments, the AI processing platform is used to provide the terminal with the AI-based CSI processing capability. In the case where the terminal supports the AI processing platform, the terminal can perform the AI-based CSI processing through the AI processing platform.

In some embodiments, the AI processing platform includes TenserFlow, which is an end-to-end open-source platform for machine learning.

In some embodiments, at least one AI processing platform/framework is predefined in the communication protocol. In the case where the support status for the AI processing platform indicates that the terminal supports any of the at least one AI processing platform/framework, the network device can determine that the terminal supports the AI-based CSI processing, meaning that the terminal has the AI-based CSI processing capability.

In some embodiments, the terminal reports the support status for the AI processing platform through the BitMap.

### Support Status for Third-Party AI Model Library

The support status for the third-party AI model library is configured to indicate the AI model supported by the terminal. In some embodiments, the AI model supported by the terminal can include at least one of the CNN model, the DNN model, the RNN model, or the Transformer model.

In some embodiments, the third-party AI model library is used to provide the terminal with the AI-based CSI processing capability. In the case where the terminal supports the third-party AI model library, the terminal can perform the AI-based CSI processing through the AI model provided in the third-party AI model library.

In some embodiments, at least one AI model is predefined in the communication protocol. In the case where the support status for the third-party AI model library indicates that the third-party AI model library supports the terminal to call any of the at least one AI model, the network device can determine that the terminal supports the AI-based CSI processing, meaning that the terminal has the AI-based CSI processing capability.

In some embodiments, the terminal reports the support status for the third-party AI model library through the BitMap.

In some embodiments, the AI-based CSI processing capability includes a minimum latency for the AI-based CSI processing. The AI-based static capability is configured to be used for determination of the minimum latency for the AI-based CSI processing of the terminal from a corresponding relationship. In some embodiments, the corresponding relationship refers to a mapping relationship between the AI-based static capability and the minimum latency for the AI-based CSI processing.

In some embodiments, the terminal also reports the AI processing speed of the terminal to the network device. The AI processing speed is configured to be used for determination of the AI-based CSI processing capability of the terminal in combination with the model information of the AI model used for the CSI processing.

In some embodiments, the terminal also reports the AI-based CSI processing capability of itself. In some embodiments, the terminal receives the model information of the AI model used for the CSI processing sent by the network device, determines the AI-based CSI processing capability of the terminal based on the model information, and reports the AI-based CSI processing capability of the terminal to the network device.

In some embodiments, the terminal also receives the allowed latency for the AI-based CSI processing configured by the network device for the terminal based on the AI-based CSI processing capability of the terminal.

According to the method for determining the AI-based CSI processing capability provided in embodiments of the present disclosure, the network device determines the AI-based CSI processing capability of the terminal based on the AI-based static capability reported by the terminal. The method provides a mechanism for the terminal to report the CSI processing capability of itself, which can provide supports for the network device in determining of the capability of the terminal, so as to configure the AI-based CSI compression that matches with the capability of the terminal.

The network device configures the CSI processing mode for the terminal based on the AI-based CSI processing capability of the terminal. The terminal switches between the CSI processing modes based on the configuration by the network device. In some embodiments, as shown in FIG. 8, the switching method for the CSI processing mode is as follows.

In step 810, a switching instruction sent by a network device is received, and the switching instruction is configured to indicate switching from a first CSI processing mode to a second CSI processing mode.

In some embodiments, the first CSI processing mode is an AI-based CSI processing mode, and the second CSI processing mode is a CSI processing mode other than the AI-based CSI processing mode. In some embodiments, the second CSI processing mode is an AI-based CSI processing mode, and the first CSI processing mode is a CSI processing mode other than the AI-based CSI processing mode. In some embodiments, the CSI processing mode other than the AI-based CSI processing mode can be a traditional CSI processing mode. In some embodiments, the latency corresponding to the AI-based CSI processing mode is less than the latency corresponding to the CSI processing mode other than the AI-based CSI processing mode.

In some embodiments, the first CSI processing mode is an AI-based CSI processing mode, and the second CSI processing mode is a CSI processing mode other than the AI-based CSI processing mode, then the switching instruction is sent by the network device to the terminal in the case where a probability of an NACK feedback from the terminal increases when the AI-based CSI compression is used.

In some embodiments, the above switching instruction includes a semi-static instruction. The semi-static instruction is configured to instruct the terminal to perform the CSI feedback according to the CSI processing mode indicated by the switching instruction within a certain period of time. In some embodiments, the feedback from the terminal when the terminal is using the AI-based CSI compression refers to the feedback on whether the data transmission is correct.

In some embodiments, the above switching instruction includes a dynamic instruction. The dynamic instruction is configured to instruct the terminal to perform the CSI feedback according to the CSI processing mode indicated by the switching instruction.

In some embodiments, in the case where the network device triggers semi-static switching for the CSI processing mode, the switching instruction is a semi-static instruction, and in the case where the network device triggers dynamic switching for the CSI processing mode, the switching instruction is a dynamic instruction.

In step 820, the first CSI processing mode is switched to the second CSI processing mode.

According to the switching method for the CSI processing mode provided in embodiments of the present disclosure, the semi-static switching and the dynamic switching between two CSI processing modes triggered by the network device are supported. Due to the fact that the semi-static instruction occupies fewer signaling resources, when the network device uses the semi-static instruction to instruct the terminal to switch CSI processing modes, signaling resources can be saved. The dynamic instruction can achieve switching between CSI processing modes more flexibly. The switching between CSI processing modes enables the CSI compression to better match with the latency requirement of terminal services and the transmission rate in the channel environment.

The terminal can also notify the network device after switching the CSI processing mode. In some embodiments, as shown in FIG. 9, the switching method for the CSI processing mode is as follows.

In step 910, the first CSI processing mode is switched to the second CSI processing mode.

In some embodiments, the first CSI processing mode is an AI-based CSI processing mode, and the second CSI processing mode is a CSI processing mode other than the AI-based CSI processing mode. In some embodiments, the second CSI processing mode is an AI-based CSI processing mode, and the first CSI processing mode is a CSI processing mode other than the AI-based CSI processing mode. In some embodiments, the CSI processing mode other than the AI-based CSI processing mode can be a traditional CSI processing mode. In some embodiments, the latency corresponding to the AI-based CSI processing mode is less than the latency corresponding to the CSI processing mode other than the AI-based CSI processing mode.

In some embodiments, the terminal switches from the first CSI processing mode to the second CSI processing mode based on a matching degree between a latency required by a service and a latency corresponding to the AI-based processing capability. In some embodiments, the terminal switches from the first CSI processing mode to the second CSI processing mode based on a matching degree between a transmission rate corresponding to the channel environment and a latency corresponding to the AI-based processing capability. In some embodiments, the above matching degree is used to indicate whether the latency corresponding to the AI-based processing capability matches or does not match with the latency required by the service. In some embodiments, the above matching degree is used to indicate whether the latency corresponding to the AI-based processing capability matches or does not match with the transmission rate corresponding to the channel environment.

In some embodiments, the terminal switches from the first CSI processing mode to the second CSI processing mode in the case where the AI-based processing capability of itself does not match with the latency requirement. In some embodiments, the latency requirement include the latency required by the service of the terminal. In some embodiments, that the latency corresponding to the AI-based processing capability does not match with the latency required by the service of the terminal includes at least one of the following:
a latency corresponding to an AI-based processing capability is greater than a maximum latency required by a service of a terminal;
a latency corresponding to an AI-based processing capability is less than a minimum latency required by a service of a terminal.

In the case where the terminal is using the first CSI processing mode, if the latency corresponding to the AI-based processing capability of the terminal is less than the minimum latency required by the service of the terminal, meaning that the AI-based processing capability of the terminal does not match with the latency required by the service of the terminal, the terminal switches from the first CSI processing mode to the second CSI processing mode.

In step 920, indication information is sent to the network device, and the indication information is configured to indicate switching from a first CSI processing mode to a second CSI processing mode.

In some embodiments, the first CSI processing mode is an AI-based CSI processing mode, and the second CSI processing mode is a CSI processing mode other than the AI-based CSI processing mode. In some embodiments, the second CSI processing mode is an AI-based CSI processing mode, and the first CSI processing mode is a CSI processing mode other than the AI-based CSI processing mode.

According to the switching method for the CSI processing mode provided in embodiments of the present disclosure, the dynamic switching between the CSI processing modes triggered by the terminal is supported, so that the flexibly switching of the CSI processing mode can be achieved, and the switching is triggered by the terminal, which can also speed up the switching efficiency of the switching of the CSI processing mode.

In some embodiments, the methods for determining the AI-based CSI processing capability in the above embodiments include aspects as follows.

### Aspect One: AI-Based Static Capability Reporting

When the terminal has the AI-based processing capability, the terminal reports at least one of the following capability to the network device.

Information of Hardware with AI-Based Processing Capability

The information of the hardware with the AI-based processing capability includes information on whether the terminal has the hardware for processing the CSI compression, for example, whether the terminal has an AI processing chip or a GPU. Regarding this information, the terminal can report whether it has the AI-based processing capability. Furthermore, the terminal can define the grade of the hardware capability based on the hardware capability, and report the grade of the hardware capability.

### Support Status for AI Processing Platform

The support status for the AI processing platform includes, for example, whether the TenserFlow is supported, etc. In some embodiments, the communication protocol can predefine at least one commonly used AI processing platform/framework. The terminal can report the support status for the AI processing platform through the BitMap.

### Support Status for Third-Party AI Model Library

The support status for the third-party AI model library includes, for example, whether the CNN model, the DNN model, the RNN model, the Transform model, etc. are supported. In some embodiments, the communication protocol can predefine at least one commonly used AI model. The terminal can report the support status for the third-party AI model library through the BitMap.

When the terminal does not have the AI-based processing capability, the terminal does not report the AI-based static capability, and the network device defaults that the terminal only supports traditional CSI processing and reporting modes.

### Aspect Two: Determination of CSI Processing Capability

When the network device determines that the terminal has the AI-based processing capability, it is necessary for the network device to further determine whether the AI-based CSI processing can meet the latency requirement.
1) The network device determines the CSI processing capability directly based on the AI-based static capability reported by the terminal. In some embodiments, the protocol predefines the mapping relationship between the AI-based static capability and the latency for the CSI processing, and the network device can determine the minimum latency for the CSI processing by the terminal based on the reported AI-based static capability.
2) The terminal further reports its AI processing speed and other parameters, and the network device determines the grade of the CSI processing capability of the terminal based on the AI processing speed reported by the terminal and the model size of the AI model to be used by the network device. The AI processing speed and other parameters reported by the terminal can be reported by the terminal actively or reported in response to the request from the network device.
3) The network device issues the model information of the AI model used for the CSI processing to the terminal. The model information can include model size information or specific model information. The terminal determines the CSI processing capability of the AI model and finally reports the grade of the CSI processing capability to the network device.

The network device determines whether to configure the AI-based CSI processing and the allowable processing latency for the terminal based on the grade of the CSI processing capability that is fed back from the terminal.

### Aspect Three: CSI Processing Mode Switching

The terminal having the AI-based processing capability can switch between the AI-based CSI processing mode and the traditional CSI processing mode.
1) The switching is triggered by the network device. In some embodiments, in the case where the network device detects that a probability of an NACK feedback from the terminal increases when the AI-based CSI compression is used, the network device can configure the terminal, so that the terminal switches to the traditional CSI processing mode (i.e. CSI feedback mode).
2) The switching is triggered by the terminal. In some embodiments, the terminal can send the request to the network device based on the current AI processing load and the matching degree for the latency requirement when using the AI-based processing, so as to switch to the traditional CSI processing mode.

According to the method for determining the AI-based CSI processing capability provided in embodiments of the present disclosure, the network device can determine the AI-based CSI processing capability of the terminal based on the AI-based static capability reported by the terminal. The method provides a mechanism for the terminal to report the CSI processing capability of itself, which can provide supports for the network device in determining of the capability of the terminal, so as to configure the AI-based CSI compression that matches with the capability of the terminal. The method can also achieve the switching of the CSI processing mode based on the AI-based processing capability.

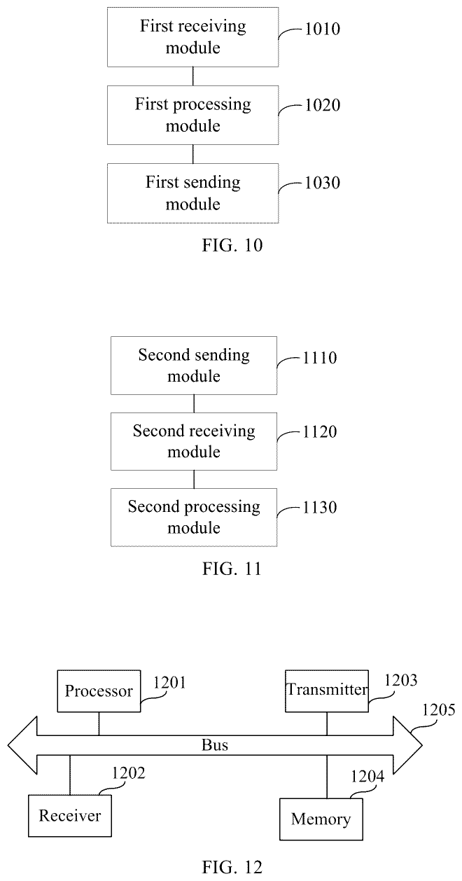

FIG. 10 shows a block diagram of an apparatus for determining an AI-based CSI processing capability according to one or more embodiments of the present disclosure. The apparatus can be implemented as part or all of a network device through software, hardware, or a combination of both. The apparatus includes a first receiving module 1010 and a first processing module 1020.

The first receiving module 1010 is configured to receive a reported AI-based static capability of a terminal.

The first processing module 1020 is configured to determine the AI-based CSI processing capability of the terminal based on the static capability.

In some embodiments, the AI-based CSI processing capability includes a minimum latency for AI-based CSI processing, and the first processing module 1020 is configured to determine the minimum latency for the AI-based CSI processing of the terminal corresponding to the static capability from a corresponding relationship. The corresponding relationship refers to a mapping relationship between the static capability and the minimum latency for the AI-based CSI processing.

In some embodiments, the static capability includes at least one of the following:
information of hardware with the AI-based processing capability;
a support status for an AI processing platform;
a support status for a third-party AI model library.

In some embodiments, the first receiving module 1010 is configured to receive a reported AI processing speed of the terminal, and the first processing module 1020 is configured to determine the AI-based CSI processing capability of the terminal based on the AI processing speed and model information of an AI model used for CSI processing.

In some embodiments, the AI processing speed is reported by the terminal to the network device actively, or the AI processing speed is reported by the terminal to the network device in response to a request from the network device.

In some embodiments, the apparatus further includes a first sending module 1030.

The first sending module 1030 is configured to send model information of an AI model used for CSI processing to the terminal, and the first receiving module 1010 is configured to receive the AI-based CSI processing capability of the terminal reported by the terminal. The AI-based CSI processing capability is determined by the terminal based on the model information.

In some embodiments, the first processing module 1020 is configured to configure an allowed latency for AI-based CSI processing for the terminal based on the AI-based CSI processing capability.

In some embodiments, the first sending module 1030 is configured to send a switching instruction to the terminal in the case where a probability of an NACK feedback from the terminal increases when AI-based CSI compression is used. The switching instruction is configured to indicate switching from a first CSI processing mode to a second CSI processing mode, the first CSI processing mode is an AI-based CSI processing mode, and the second CSI processing mode is a CSI processing mode other than the AI-based CSI processing mode.

In some embodiments, the first receiving module 1010 is configured to receive indication information reported by the terminal. The indication information is configured to indicate switching from a first CSI processing mode to a second CSI processing mode, the first CSI processing mode is an AI-based CSI processing mode, and the second CSI processing mode is a CSI processing mode other than the AI-based CSI processing mode.

In some embodiments, the indication information is reported by the terminal to the network device, after the terminal switches, in response to the AI-based processing capability of the terminal not matching with a latency requirement, from the first CSI processing mode to the second CSI processing mode.

FIG. 11 shows a block diagram of an apparatus for determining an AI-based CSI processing capability according to one or more embodiments of the present disclosure. The apparatus can be implemented as part or all of a terminal through software, hardware, or a combination of both. The apparatus includes a second sending module 1110.

The second sending module 1110 is configured to an AI-based static capability of the terminal to a network device. The AI-based static capability is configured to be used for determination of the AI-based CSI processing capability.

In some embodiments, the AI-based CSI processing capability includes a minimum latency for AI-based CSI processing, the AI-based static capability is configured to be used for determination of the minimum latency for the AI-based CSI processing of the terminal from a corresponding relationship, and the corresponding relationship refers to a mapping relationship between the static capability and the minimum latency for the AI-based CSI processing.

In some embodiments, the static capability includes at least one of the following:
information of hardware with the AI-based processing capability;
a support status for an AI processing platform;
a support status for a third-party AI model library.

In some embodiments, the second sending module 1110 is configured to report an AI processing speed of the terminal to the network device. The AI processing speed is configured to be used for the determination of the AI-based CSI processing capability in combination with model information of an AI model used for CSI processing.

In some embodiments, the apparatus further includes a second receiving module 1120 and a second processing module 1130.

The second receiving module 1120 is configured to receive model information of an AI model used for CSI processing sent by the network device.

The second processing module 1130 is configured to determine the AI-based CSI processing capability of the terminal based on the model information.

The second sending module 1110 is configured to report the AI-based CSI processing capability of the terminal to the network device.

In some embodiments, the second receiving module 1120 is configured to receive an allowed latency for AI-based CSI processing. The allowed latency for the AI-based CSI processing is configured by the network device for the terminal based on the AI-based CSI processing capability of the terminal.

In some embodiments, the second receiving module 1120 is configured to receive a switching instruction sent by the network device. The switching instruction is configured to indicate switching from a first CSI processing mode to a second CSI processing mode, and the switching instruction is sent by the network device to the terminal in the case where a probability of an NACK feedback from the terminal increases when AI-based CSI compression is used. The first CSI processing mode is an AI-based CSI processing mode, and the second CSI processing mode is a CSI processing mode other than the AI-based CSI processing mode.

In some embodiments, the second sending module 1110 is configured to send indication information to the network device. The indication information is configured to indicate switching from a first CSI processing mode to a second CSI processing mode, the first CSI processing mode is an AI-based CSI processing mode, and the second CSI processing mode is a CSI processing mode other than the AI-based CSI processing mode.

In some embodiments, the second processing module 1130 is configured to switch, in response to the AI-based processing capability of the terminal not matching with a latency requirement, from the first CSI processing mode to the second CSI processing mode.

FIG. 12 shows a schematic diagram of a structure of UE provided in one or more embodiments of the present disclosure. The UE includes a processor 1201, a receiver 1202, a transmitter 1203, a memory 1204, and a bus 1205.

The processor 1201 includes one or more processing cores, which execute various functional applications and information processing by running software programs and modules.

The receiver 1202 and the transmitter 1203 can be embodied as a communication component, which can be a communication chip.

The memory 1204 is connected to the processor 1201 through the bus 1205.

The memory 1204 can be configured to store at least one program code, and the processor 1201 is configured to execute the at least one program code to implement the various steps in the above method embodiments.

In addition, the memory 1204 can be embodied by any type of volatile or non-volatile storage device, or a combination thereof. Volatile or non-volatile storage devices include but are not limited to: magnetic disks or optical discs, electrically erasable programmable read-only memory (EEPROM), erasable programmable read-only memory (EPROM), static random-access memory (SRAM), read-only memory (ROM), magnetic memory, flash memory, and programmable read-only memory (PROM).

In some embodiments, a non-transitory computer-readable storage medium including instructions is also provided, such as a memory including instructions, which can be executed by the processor of UE to implement the method for determining the AI-based CSI processing capability described above. For example, the non-transitory computer-readable storage medium can be ROM, random-access memory (RAM), compact disc read-only memory (CD-ROM), magnetic tape, floppy disk, and optical data storage device, etc.

In some embodiments, a non-transitory computer-readable storage medium is provided, and when the instructions in the non-transitory computer-readable storage medium are executed by a processor of UE, the user equipment (UE) is enabled to perform the method for determining the AI-based CSI processing capability described above.

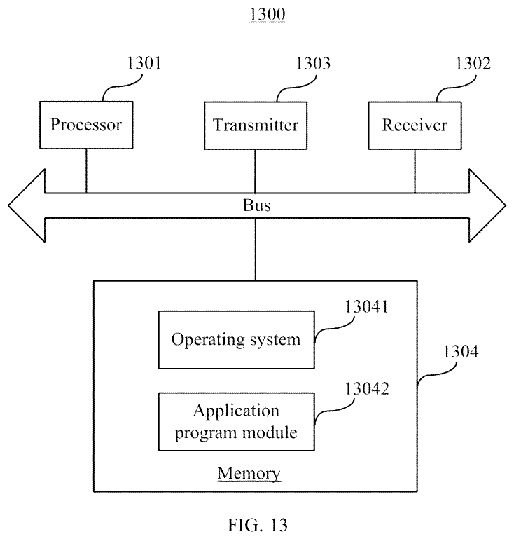

FIG. 13 is a block diagram of a network device 1300 according to one or more embodiments of the present disclosure. The network device 1300 can be a base station.

The network device 1300 can include a processor 1301, a receiver 1302, a transmitter 1303, and a memory 1304. The receiver 1302, the transmitter 1303, and the memory 1304 are respectively connected to the processor 1301 through a bus.

In some embodiments, the processor 1301 includes one or more processing cores, and the processor 1301 implements the method for determining the AI-based CSI processing capability provided in embodiments of the present disclosure by running software programs and modules. The memory 1304 can store software programs and modules. In some embodiments, the memory 1304 can store an operating system 13041 and at least one application program module 13042 required for a specific function. The receiver 1302 is used to receive communication data sent by other devices, and the transmitter 1303 is used to send communication data to other devices.

Embodiments of the present disclosure also provide a computer-readable storage medium, which stores at least one instruction, at least one program, a code set, or an instruction set. The at least one instruction, the at least one program, the code set, or the instruction set is loaded and executed by a processor to cause the method for determining the AI-based CSI processing capability provided in the above method embodiments to be implemented.

Embodiments of the present disclosure also provide a computer program product including computer instructions stored in a computer-readable storage medium. A processor of a computer device reads and executes the computer instructions from the computer-readable storage medium, to cause the computer device to implement the method for determining the AI-based CSI processing capability provided in various method embodiments described above.

It should be understood that the term “multiple” mentioned in the present disclosure refers to two or more. The term “and/or” describes the association relationship between associated objects, indicating that there can be three relationships. For example, A and/or B, which can represent A exists alone, A and B exist simultaneously, and B exists alone. The character “/” generally indicates that the associated objects before and after are in an “or” relationship.

After considering the specification and practicing the embodiments disclosed herein, those skilled in the art will easily come up with other embodiments of the present disclosure. The present disclosure is intended to cover any variations, uses, or adaptive changes of the present disclosure that follow the general principles of the present disclosure and include common knowledge or customary technical means in the art that are not disclosed herein. The specification and embodiments are considered as exemplary only, and the true scope and spirit of the present disclosure are indicated by the appended claims.

It should be understood that the present disclosure is not limited to the precise structure described above and shown in the drawings, and various modifications and changes can be made without departing from the scope thereof. The scope of the present disclosure is limited only by the appended claims.

1. A method for determining an AI-based CSI processing capability, performed by a network device, the method comprising:
receiving a reported Artificial Intelligence (AI) based static capability of a terminal; and
determining the AI-based Channel State Information (CSI) processing capability of the terminal based on the static capability.

2. The method according to claim 1, wherein the AI-based CSI processing capability comprises a minimum latency for AI-based CSI processing, and wherein determining the AI-based CSI processing capability of the terminal based on the static capability comprises:
determining the minimum latency for the AI-based CSI processing of the terminal corresponding to the static capability from a corresponding relationship, wherein the corresponding relationship comprises a mapping relationship between the static capability and the minimum latency for the AI-based CSI processing.

3. The method according to claim 2, wherein the static capability comprises at least one of:
information of hardware with the AI-based processing capability;
a support status for an AI processing platform; or
a support status for a third-party AI model library.

4. The method according to claim 1, further comprising:
receiving a reported AI processing speed of the terminal; and
determining the AI-based CSI processing capability of the terminal based on the AI processing speed and model information of an AI model used for CSI processing.

5. (canceled)

6. The method according to claim 1, further comprising:
sending model information of an AI model used for CSI processing to the terminal; and
receiving the AI-based CSI processing capability of the terminal reported by the terminal, wherein the AI-based CSI processing capability is determined by the terminal based on the model information.

7. The method according to claim 61, further comprising:
configuring an allowed latency for AI-based CSI processing for the terminal based on the AI-based CSI processing capability.

8. The method according to claim 1, further comprising:
sending a switching instruction to the terminal in the case where a probability of a Negative Acknowledgement (NACK) feedback from the terminal increases when AI-based CSI compression is used, wherein the switching instruction is configured to indicate switching from a first CSI processing mode to a second CSI processing mode, and wherein the first CSI processing mode is an AI-based CSI processing mode, and the second CSI processing mode is a CSI processing mode other than the AI-based CSI processing mode.

9. The method according to claim 1, further comprising:
receiving indication information reported by the terminal, wherein the indication information is configured to indicate switching from a first CSI processing mode to a second CSI processing mode, and wherein the first CSI processing mode is an AI-based CSI processing mode, and the second CSI processing mode is a CSI processing mode other than the AI-based CSI processing mode.

10. The method according to claim 9, wherein the indication information is reported by the terminal to the network device, after the terminal switches, in response to the AI-based processing capability of the terminal not matching with a latency requirement, from the first CSI processing mode to the second CSI processing mode.

11. A method for determining an AI-based CSI processing capability, performed by a terminal, the method comprising:
reporting an Artificial Intelligence (AI) based static capability of the terminal to a network device, wherein the AI-based static capability is configured to be used for determination of the AI-based Channel State Information (CSI) processing capability.

12. The method according to claim 11, wherein the AI-based CSI processing capability comprises a minimum latency for AI-based CSI processing, and wherein the AI-based static capability is configured to be used for determination of the minimum latency for the AI-based CSI processing of the terminal from a corresponding relationship, and the corresponding relationship comprises a mapping relationship between the static capability and the minimum latency for the AI-based CSI processing.

13. The method according to claim 12, wherein the static capability comprises at least one of:
information of hardware with the AI-based processing capability;
a support status for an AI processing platform; or
a support status for a third-party AI model library.

14. The method according to claim 11, further comprising:
reporting an AI processing speed of the terminal to the network device, wherein the AI processing speed is configured to be used for the determination of the AI-based CSI processing capability in combination with model information of an AI model used for CSI processing.

15. The method according to claim 11, further comprising:
receiving model information of an AI model used for CSI processing sent by the network device;
determining the AI-based CSI processing capability of the terminal based on the model information; and
reporting the AI-based CSI processing capability of the terminal to the network device.

16. The method according to claim 11, further comprising:
receiving an allowed latency for AI-based CSI processing, wherein the allowed latency for the AI-based CSI processing is configured by the network device for the terminal based on the AI-based CSI processing capability of the terminal.

17. The method according to claim 11, further comprising:
receiving a switching instruction sent by the network device, wherein the switching instruction is configured to indicate switching from a first CSI processing mode to a second CSI processing mode, and the switching instruction is sent by the network device to the terminal in the case where a probability of a Negative Acknowledgement (NACK) feedback from the terminal increases when AI-based CSI compression is used, and wherein the first CSI processing mode is an AI-based CSI processing mode, and the second CSI processing mode is a CSI processing mode other than the AI-based CSI processing mode.

18. The method according to claim 11, further comprising:
sending indication information to the network device, wherein the indication information is configured to indicate switching from a first CSI processing mode to a second CSI processing mode, and wherein the first CSI processing mode is an AI-based CSI processing mode, and the second CSI processing mode is a CSI processing mode other than the AI-based CSI processing mode.

19. The method according to claim 18, before sending the indication information to the network device, the method comprising:
switching, in response to the AI-based processing capability of the terminal not matching with a latency requirement, from the first CSI processing mode to the second CSI processing mode.

20.-21. (canceled)

22. A network device, comprising:
a processor;
a memory for storing executable instructions; and
a transceiver connected to the processor;
wherein the processor is configured to load and execute the executable instructions to cause the method for determining the AI-based CSI processing capability according to claim 1 to be implemented.

23. A terminal, comprising:
a processor;
a memory for storing executable instructions; and
a transceiver connected to the processor;
wherein the processor is configured to load and execute the executable instructions to cause the method for determining the AI-based CSI processing capability according to claim 11 to be implemented.

24.-26. (canceled)
